(19) United States
(12) Patent Application Publication
(10) Pub. No.: US 2018/0148258 A1
(43) Pub. Date: May 31, 2018

(54) VENTILATED TRASH CAN

(71) Applicants: Ali Andrade, Creastview, FL (US); Ambur Andrade, Creastview, FL (US)

(72) Inventors: Ali Andrade, Creastview, FL (US); Ambur Andrade, Creastview, FL (US)

(21) Appl. No.: 15/364,491

(22) Filed: Nov. 30, 2016

(51) Int. Cl. B65F 1/14; B65F 1/06

(52) U.S. Cl. CPC B65F 1/14; B65F 1/06; B65F 2210/1815; B65F 1/065; B65F 2210/129; B65F 1/068

(57) ABSTRACT

A trash can that includes: four sides where the four sides include two first opposing sides and two second opposing sides; a vent system at the bottom of each second opposing side; and a top opening. The vent system preferably includes a plurality of holes, wherein the holes include air fresheners.

### BACKGROUND OF THE INVENTION

### Field of Invention

The present invention relates to a trash can and includes a ventilation opening to allow for the passage of air.

### Description of Related Art

A typical trash can in a residential home is usually rectangular or tubular and requires use of a plastic bag so that trash may be readily removed to avoid staining or residue buildup within the trash can. Individuals usually wrap the bag within the trash can and remove the plastic bag once fully consumed. However once stuffed sometimes these bags are difficult to remove from the trash can. A suction is usually created that resists the removal of the bag from the can. Further, a trash can accumulate a pungent smell over a period of time. As a result, it would be advantageous to have a ventilation system within the can that allows the flow of air to assist in the removal of trash bags and in the reduction of pungent smells that are usually associated with trash.

### SUMMARY OF THE INVENTION

The present invention relates to a trash can that includes: four sides where the four sides include two first opposing sides and two second opposing sides; a vent system at the bottom of each second opposing side; and a top opening. The vent system preferably includes a plurality of holes, wherein the holes include air fresheners.

### BRIEF DESCRIPTION OF DRAWINGS

FIG. 1 depicts a trash can with ventilation in accordance with the present invention.

### DETAILED DESCRIPTION

The present invention relates to a trash can that includes a ventilation system incorporated on side panels of the trash can. Preferably the ventilation system is installed at the bottom of two opposing sides of a rectangular cube shaped trash can. The ventilation system includes venting holes that allow for the transfer of air into the interior of the trash can. Further venting holes may include air freshening apparatuses installed therefore providing a more pleasant smell associated with the trash can. The venting system further aids in the insertion and removal of trash bags as needed by the user.

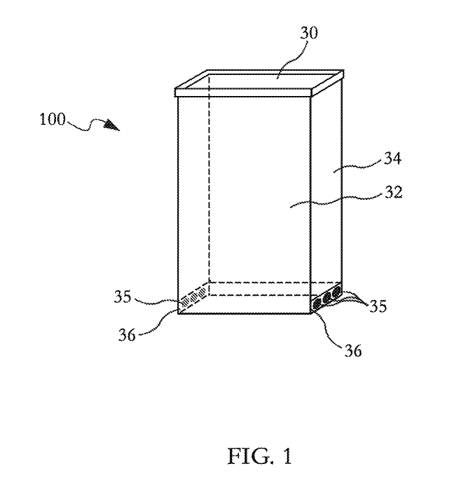

In reference to FIG. 1, a Trash Can 100 in accordance with the present invention is depicted. The Trash Can 100 includes Opening 30 at the top and is preferably rectangular cube shaped as shown in FIG. 1. The Opening 30 allows for the insertion of trash bags that may be wrapped around the rim of the trash can for support. Other aspects of Trash Can 100 include Side 32 and Side 34. As shown Side 32 is longer than Side 34 and extends across the width of the trash can. The Side 34 has a shorter length and includes a Vent System 30 at the bottom thereof. The Vent System 30 includes a series of Vent Holes 35 that allow for the transfer of air into the interior of the Trash Can 100. A similar vent system although not shown is on the opposing side of Side 34. The Vent Holes 35 include air fresheners to allow for the transfer of fresh scented air into the trash can. The trash can according to present invention provides a solution to odors associated with the can and also assist in the removal of the trash bags from the Trash Can 100.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A trash can comprising:
a. four sides where the four sides include two first opposing sides and two second opposing sides;
b. a vent system at the bottom of each second opposing side; and
c. a top opening.

2. The trash can according to claim 1, wherein the vent system includes a plurality of holes.

3. The trash can according to claim 2, wherein the vent holes include air fresheners.
